(19) United States
(12) Patent Application Publication
(10) Pub. No.: US 2019/0084863 A1
(43) Pub. Date: Mar. 21, 2019

(54) METHOD FOR PRODUCING OPTICAL ELEMENT

(71) Applicant: OLYMPUS CORPORATION, Tokyo (JP)

(72) Inventors: Yusuke NAKAGAWA, Tokyo (JP); Taku NOSE, Tokyo (JP)

(73) Assignee: OLYMPUS CORPORATION, Tokyo (JP)

(21) Appl. No.: 16/164,409

(22) Filed: Oct. 18, 2018

Related U.S. Application Data
(63) Continuation of application No. PCT/JP2017/018919, filed on May 19, 2017.

(30) Foreign Application Priority Data
May 23, 2016 (JP) 2016-102540

(51) Int. Cl. C03B 11/12

(52) U.S. Cl. CPC C03B 11/122; C03B 2215/76; C03B 2215/46; C03B 11/125

(57) ABSTRACT

A method of producing an optical element includes: determining, as a reference mold set, a first mold set from among mold sets; determining a set temperature for the reference mold set; acquiring reference data by measuring, by a temperature measurement sensor, a temperature of the reference mold set; measuring, by the temperature measurement sensor, a temperature of a second mold set that is at least one of the mold sets other than the reference mold set; calculating a correction value based on a measurement result obtained by the measuring and on the reference data; determining a set temperature for the second mold set based on the set temperature for the reference mold set and on the correction value; and performing temperature control on the mold sets based on set temperatures determined for the respective mold sets to produce the optical elements.

### CROSS-REFERENCE TO RELATED APPLICATION

This application is a continuation of PCT International Application No. PCT/JP2017/018919 filed on May 19, 2017 which claims the benefit of priority from Japanese Patent Application No. 2016-102540, filed on May 23, 2016, the entire contents of which are incorporated herein by reference.

### BACKGROUND

### 1. Technical Field

The present disclosure relates to an optical element mold to produced optical elements.

### 2. Related Art

As a producing method of optical elements, a method in which an optical element material is arranged in a mold and is heated and pressed to be formed into an optical element in a desirable shape has been known. In this type of molding of optical element, one of the requirements to produce optical elements with reduced variations is highly accurate temperature control of the mold.

For example, in Japanese Laid-open Patent Publication No. 2004-137146, an apparatus for producing an optical element that inserts a thermocouple into the inside of a mold, and heats the mold while controlling the temperature with this thermocouple is described.

The apparatus for producing an optical element described above is required to bring the temperature of a mold to a molding temperature from a room temperature with a single molding, and down to a cooling temperature from the molding temperature and, therefore, takes certain time to bring up and down the temperature of the mold. In addition, the time to bring the temperature up and down increases as the size of an optical element (=the size of the mold) increases. Therefore, in the apparatus for producing an optical element, it becomes necessary to produce optical elements having the same optical property (shape) with multiple molds according to a necessary quantity of production.

However, temperature sensors (for example, a thermocouple, platinum resistance thermometer sensor) used for the temperature control of molds have a tolerance considering production errors. For example, when the temperature is 500° C., a thermocouple (type K, E, T, class 1) has a tolerance of ±2° C., and a platinum resistance thermometer sensor (Pt100) has a tolerance of ±2.8° C. (refer to Japan Industrial Standards (JIS) “JIS C 1602” and “JIS C 1604”). As described, even temperature sensors same in terms of standards have individual differences in an actual situation.

Accordingly, in the apparatus for producing an optical element, even if the temperature of the molds is tried to be controlled to the same temperature by the thermal couple, the same temperature condition cannot be obtained in an actual state due to the individual differences described above, resulting in variations in quality (for example, the shape of an optically functioning surface) of optical elements among the molds.

### SUMMARY

In some embodiments, provide is a method of producing an optical element to produce optical elements having same properties among mold sets while performing temperature control on the mold sets to have a predetermined set temperature by using a temperature control sensor that is inserted in each mold set. The method includes: determining, as a reference mold set, a first mold set from among the mold sets; determining a set temperature for the reference mold set; acquiring reference data by measuring, by a temperature measurement sensor, a temperature of the reference mold set that has been heated such that a measurement value of a first temperature control sensor that is inserted in the reference mold set indicates the set temperature; measuring, by the temperature measurement sensor, a temperature of a second mold set that has been heated such that a measurement value of a second temperature control sensor that is inserted in the second mold set becomes the set temperature, the second mold set being at least one of the mold sets other than the reference mold set; calculating a correction value based on a measurement result obtained by the measuring and on the reference data; determining a set temperature for the second mold set based on the set temperature for the reference mold set and on the correction value; and performing temperature control on the mold sets based on set temperatures determined for the respective mold sets to produce the optical elements.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a cross-section showing a configuration of an apparatus for producing an optical element that includes an optical element mold according to an embodiment of the present disclosure; and

FIG. 2 is a flowchart showing a method of acquiring correction data of a temperature sensor, using the optical element mold according to the embodiment of the present disclosure.

### DETAILED DESCRIPTION

An embodiment of an optical element mold according to the present disclosure is explained below, referring to the drawings. The present disclosure is not limited to the following embodiments. The components in the following embodiment include ones easily replaced by those skilled in the art, or ones practically the same.

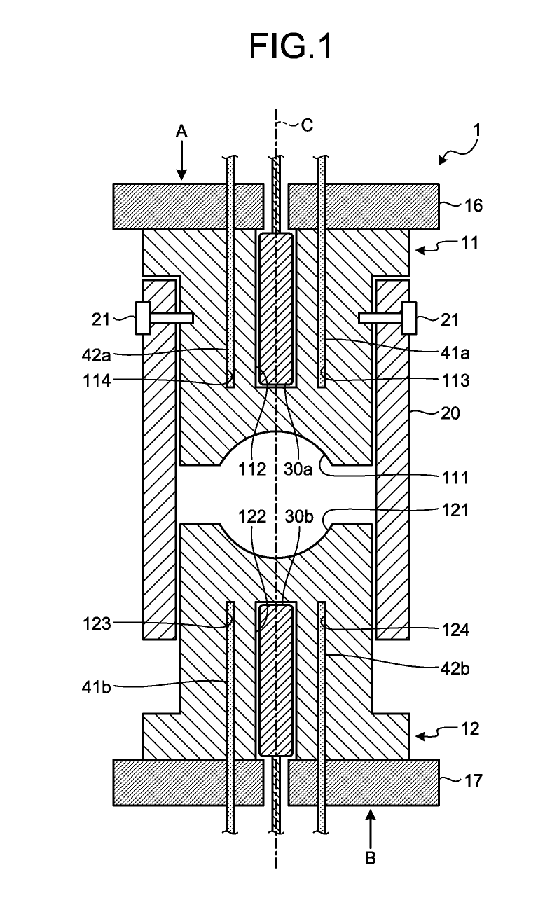

A configuration of an apparatus for producing an optical element that includes an optical element mold according to the embodiment is explained, referring to FIG. 1. An apparatus for producing an optical element 1 includes an optical element mold, an upper base 16, a lower base 17, a sleeve 20, heaters 30a, 30b, temperature control sensors 41a, 41b, and temperature measurement sensors 42a, 42b.

The optical element mold is to form an optical element, such as a glass lens, and includes an upper mold 11 and a lower mold 12. The upper mold 11 and the lower mold 12 are both formed in a cylindrical shape with a step (convex shape), and are arranged such that respective molding surfaces 111 and 121 face to each other in the sleeve 20. Moreover, the upper mold 11 and the lower mold 12 are positioned by the sleeve 20 such that the respective molding surfaces 111 and 121 are concentric. The molding surfaces 111 and 121 are surfaces to form optically functioning surfaces of an optical element, and are formed in inverted shapes of a desirable optical element.

The upper mold 11 is fixed to the upper base 16. On one of end surfaces (on a side closer to the lower mold 12) of the upper mold 11, the molding surface 111 is formed. Furthermore, in the upper mold 11, a heater insertion hole 112 having an opening on the other one of the end surfaces (on a side closer to the upper base 16) is formed. Moreover, in the upper mold 11, at least two temperature-sensor insertion holes, namely, a temperature-sensor insertion hole 113 and a temperature-sensor insertion hole 114, having an opening on the other one of the end surfaces (on the side closer to the upper base 16) are formed.

The heater insertion hole 112 is to insert the heater 30a therein, and is formed in a predetermined depth along a center axis C of the optical element mold from the other end surface of the upper mold 11 toward the lower mold 12.

The temperature-sensor insertion holes 113, 114 are to insert the temperature sensor 41a for temperature control and the temperature sensor 42a for measurement therein, and are formed in the same depth, parallel to the center axis C from the other end surface of the upper mold 11 toward the lower mold 12.

The depth of the temperature-sensor insertion holes 113, 114 can be appropriately changed according to the shape of the molding surface 111. For example, when the molding surface 111 is concave as shown in FIG. 1, the temperature-sensor insertion holes 113, 114 can be formed such that positions (bottom portions) thereof are at a deep position (close to the molding surface 111) relative to a position (bottom portion) of the heater insertion hole 112. Moreover, for example, when the molding surface 111 is convex, the temperature-sensor insertion holes 113, 114 can be formed such that the positions (bottom portions) thereof are at a shallow position (far from the molding surface 111) relative to the position (bottom portion) of the heater insertion hole 112.

The temperature-sensor insertion holes 113, 114 are arranged at rotationally-symmetrical positions with respect to the center axis C. In the present embodiment, the temperature-sensor insertion holes 113, 114 are formed at positions opposing to each other about the center axis C. That is, the temperature-sensor insertion hole 113 is arranged at a position rotated about the center axis C by 180 degrees from the temperature-sensor insertion hole 114, for example, when the upper mold 11 is viewed from a direction of an arrow A.

Thus, a distance between the temperature sensor 41a for temperature control and the heater 30a and a distance between the temperature sensor 42a for measurement and the heater 30a are the same, and the temperature of the upper mold 11 can be detected under the same condition as the temperature sensor 41a for temperature control by the temperature sensor 42a for measurement. Therefore, measurement errors of the temperature sensor 42a for measurement can be reduced.

Note that as long as the temperature-sensor insertion holes 113, 114 are arranged rotationally symmetrically with respect to the center axis C, the configuration is not limited to that shown in FIG. 1. That is, the temperature-sensor insertion hole 113 can be arranged at a position rotated about the center axis C by an angle other than 180 degrees (45 degrees, 90 degrees, 270 degrees, or the like) from the temperature-sensor insertion hole 114 when the upper mold 11 is viewed from the direction of the arrow A.

The lower mold 12 is fixed to the lower base 17. On one of end surfaces (on a side closer to the upper mold 11) of the lower mold 12, a molding surface 121 is formed. Furthermore, in the lower mold 12, a heater insertion hole 122 having an opening on the other one of the end surfaces (on a side closer to the lower base 17) is formed. Moreover, in the lower mold 12, at least two temperature-sensor insertion holes, namely, a temperature-sensor insertion hole 123 and a temperature-sensor insertion hole 124 having an opening on the other one of the end surfaces (on the side closer to the lower base 17) are formed.

The heater insertion hole 122 is to insert the heater 30b therein, and is formed in a predetermined depth along the center axis C of the optical element mold from the other end surface of the lower mold 12 toward the upper mold 11.

The temperature-sensor insertion holes 123, 124 are to insert the temperature sensor 41a for temperature control and the temperature sensor 42a for measurement therein, and are formed in the same depth, parallel to the center axis C from the other end surface of the lower mold 12 toward the upper mold 11.

The depth of the temperature-sensor insertion holes 123, 124 can be appropriately changed according to the shape of the molding surface 121. For example, when the molding surface 121 is concave as shown in FIG. 1, the temperature-sensor insertion holes 123, 124 can be formed such that positions (bottom portions) thereof are at a deep position (close to the molding surface 121) relative to a position (bottom portion) of the heater insertion hole 122. Moreover, for example, when the molding surface 121 is convex, the temperature-sensor insertion holes 123, 124 can be formed such that the positions (bottom portions) thereof are at a shallow position (far from the molding surface 121) relative to the position (bottom portion) of the heater insertion hole 122.

The temperature-sensor insertion holes 123, 124 are arranged at rotationally-symmetrical positions with respect to the center axis C. In the present embodiment, the temperature-sensor insertion holes 123, 124 are formed at positions opposing to each other about the center axis C. That is, the temperature-sensor insertion hole 123 is arranged at a position rotated about the center axis C by 180 degrees from the temperature-sensor insertion hole 124, for example, when the lower mold 12 is viewed from a direction of an arrow B.

Thus, a distance between the temperature sensor 41b for temperature control and the heater 30b and a distance between the temperature sensor 42b for measurement and the heater 30b are the same, and the temperature of the lower mold 12 can be detected under the same condition as the temperature sensor 41b for temperature control by the temperature sensor 42b for measurement. Therefore, measurement errors of the temperature sensor 42b for measurement can be reduced.

Note that as long as the temperature-sensor insertion holes 123, 124 are arranged rotationally symmetrically with respect to the center axis C, the arrangement is not limited to that shown in FIG. 1. The temperature-sensor insertion holes 123, 124 can be arranged at position not opposing to each other about the center axis C. That is, the temperature-sensor insertion hole 123 can be arranged at a position rotated about the center axis C by an angle other than 180 degrees (45 degrees, 90 degrees, 270 degrees, or the like) from the temperature-sensor insertion hole 124 when the lower mold 12 is viewed from the direction of the arrow B.

The sleeve 20 is to control relative positions of the upper mold 11 and the lower mold 12. The sleeve 20 is formed in a cylindrical shape, and is fixed to a periphery of the upper mold 11 by a fixing member 21.

The heaters 30a, 30b are inserted in the heater insertion holes 112, 122, respectively, and heat up and cooled down the upper mold 11 and the lower mold 12 at the time of molding an optical element.

The temperature control sensors 41a, 41b detect the temperature of the upper mold 11 and the lower mold 12, respectively. Each of the temperature control sensors 41a, 41b is formed in a rod shape, and is constituted of, for example, a thermocouple or a platinum resistance thermometer. The temperature control sensors 41a, 41b are attached to the upper mold 11 and the lower mold 12 all the time, respectively, and are used when performing temperature control of an optical element mold. In the following, explanation is given, assuming that a thermocouple is used as the temperature control sensors 41a, 41b.

The temperature control sensors 41a, 41b and the heaters 30a, 30b are connected to a controller (control device) not shown. Based on an indication value of the temperature control sensors 41a, 41b, output of the heaters 30a, 30b is controlled to heat and cool the upper mold 11 and the lower mold 12.

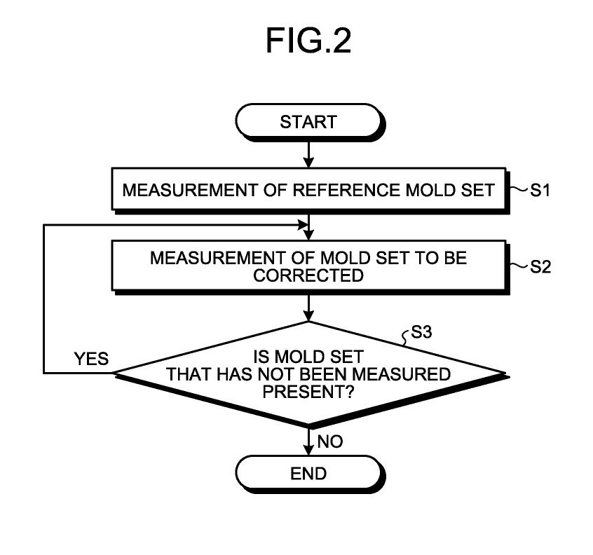

The temperature measurement sensors 42a, 42b detect the temperature of the upper mold 11 and the lower mold 12, respectively. Each of the temperature measurement sensors 42a, 42b is formed in a rod shape, and is constituted of, for example, a thermocouple or a platinum resistance thermometer. The temperature measurement sensors 42a, 42b are used only in a preparation process (refer to FIG. 2) prior to optical element molding described later, and are removed from the upper mold 11 and the lower mold 12 in a molding process of an optical element. Specifically, the temperature measurement sensors 42a, 42b are used to measure individual differences of the temperature control sensors 41a, 41b among multiple optical element molds. In the following, explanation is given, assuming that a thermocouple is used as the temperature measurement sensors 42a, 42b.

The temperature measurement sensors 42a, 42b are connected to a monitor (display device) not shown through the controller, to be configured such that the indication values can be viewed on the monitor.

According to the optical element mold having the configuration as described above, the temperature control sensors 41a, 41b and the temperature measurement sensors 42a, 42b are inserted in the temperature-sensor insertion holes 113, 123, 114, 124, respectively, and temperatures of the optical element molds that are heated by the respective temperature control sensors 41a, 41b are measured by the same temperature measurement sensors 42a, 42b, thereby enabling to grasp the individual differences of the temperature control sensors 41a, 41b among the optical element molds. By adjusting the set temperature for temperature control by the temperature control sensors 41a, 41b based on the individual differences described above at the time of molding optical elements, the temperature conditions among the optical element molds can be consistent. Therefore, it is possible to prevent variations in quality of optical elements among multiple optical element molds, and to produce an optical element having a desired optical property stably.

### Method of Acquiring Correction Data

In the following, a method of acquiring correction data of a temperature sensor using an optical element mold is explained, referring to FIG. 2. The respective processing shown in the figure are performed as a preparation process prior to molding an optical element, and a molding process of an optical element is performed after these processing.

First, a reference mold set is measured, and reference data is acquired (step S1). The “mold set” signifies the apparatus for producing an optical element 1 that includes an optical element mold as shown in FIG. 1.

At this step, a reference mold set is selected among multiple molds to mold optical elements that have a uniform optical property (shape). The reference mold set can be selected, for example, randomly from among plural mold sets, or a mold set with which an optical element having the best quality have been produced can be selected as the reference mold set.

Next, in the reference mold set, the upper mold 11 and the lower mold 12 are heated such that an indication value of the temperature control sensors 41a, 41b of the reference mold set (hereinafter, “reference temperature control sensors 41a, 41b”) shows a predetermined value (for example, 600° C.). Furthermore, the temperatures of the upper mold 11 and the lower mold 12 are measured by the temperature measurement sensors 42a, 42b, and its indication value (for example, 598° C.) is acquired. This indication value (598° C.) is to be the reference data.

Subsequently, a mold set to be corrected is measured, and correction data is acquired (step S2). At this step, in the mold set subject to correction, the upper mold 11 and the lower mold 12 are heated such that an indication value of the temperature control sensors 41a, 41b of the mold set (hereinafter, “subject-to-correction temperature control sensors 41a, 41b” shows a predetermined value (for example, 600° C.) similarly to the reference temperature control sensors 41a, 41b.

Furthermore, the temperatures of the upper mold 11 and the lower mold 12 are measured by the temperature measurement sensors 42a, 42b used at step S1, and its indication value (for example, 602° C.) is acquired. A difference (4° C.) between this indication value (602° C.) and the reference data (598° C.) is an individual difference between the reference temperature control sensors 41a, 41b and the subject-to-correction temperature control sensors 41a, 41b. This individual difference (4° C.) is to be the correction data (correction value) to correct the mold set subject to correction.

As the correction data, a value of the individual difference itself can be used as described above, or a value rounded off to the nearest integer, for example, when the individual difference includes a decimal, or the like can be used.

Subsequently, it is determined whether a mold set that has not been measured is present (step S3). When a mold set that has not been measured is present (step S3: YES), it returns to step S2 to continue acquiring correction data, and when a mold set that has not been measured is not present (step S3: NO), the processing is ended. The correction data acquired by the above processing is used when correcting the set temperature of a mold set subject to correction in the molding process of an optical element at a later stage. For example, when the individual difference between the reference temperature control sensors 41a, 41b and the subject-to-correction temperature control sensors 41a, 41b is 4° C. as described above, the set temperature (heating temperature) for a mold set in which the subject-to-correction temperature control sensors 41a, 41b are provided is corrected from the original setting, 600° C. to 596° C.

Thus, the temperature of the mold set subject to correction (the indication value of the temperature measurement sensors 42a, 42b) at the time of molding is decreased from the temperature before correction (602° C.) to be the same as the temperature (598° C.) of the reference mold set at the time of molding or temperature close to that. Therefore, although the indication values of the temperature control sensors 41a, 41b show different values between two mold sets (reference: 600° C., subject to correction: 596° C.), the actual temperatures of the two mold sets can be close to each other around 598° C. As a result, it is possible to prevent variations in quality of optical element among plural mold sets, and to produce optical elements having a desired optical property stably.

### EXAMPLE

In the following, an optical element mold according to the present disclosure is more specifically explained with an example. In this example, a case in which correction data is acquired by the above processing shown in FIG. 2, to make temperature conditions of four mold sets consistent is explained. Moreover, in the following, a case in which a first mold set is the reference and remaining second to fourth mold sets are subject to correction, and the temperature conditions of the second to the fourth mold sets are adjusted to be the same as the first mold set is explained.

TABLE 1

| | | Reference | Subject to correction | | |
|---|---|---|---|---|---|
| Mold set | | First | Second | Third | Fourth |
| Indication value | Upper | 600.0 | | | |
| of temperature | mold | | | | |
| control sensor | Lower | | | | |
| [C.°] | mold | | | | |
| Indication value | Upper | 599.3 | 599.0 | 600.3 | 596.0 |
| of temperature | mold | | | | |
| measurement sensor | Lower | 596.1 | 599.3 | 599.5 | 596.7 |
| [C.°] | mold | | | | |
| Individual | Upper | — | 0.3 | −1.0 | 3.3 |
| difference of | mold | | | | |
| temperature | Lower | — | −3.2 | −3.4 | −0.6 |
| control sensor | mold | | | | |
| [C.°] | | | | | |

Table 1 shows individual differences of temperature control sensors of the first to the fourth mold sets (hereinafter, “first to fourth temperature control sensors ”) before correction. In Table 1, “indication value of temperature control sensor” is a temperature to be set when controlling the temperature of the first to fourth mold sets (the upper molds and the lower molds), and shows the original indication value of the temperature control sensor. Furthermore, “indication value of temperature measurement sensor” shows an indication value of the temperature measurement sensor when controlling the temperature of the first to fourth mold sets based on the “indication value of temperature control sensor” described above. Moreover, “individual difference of temperature control sensor” shows an individual difference of the second to the fourth temperature control sensor with respect to the first temperature control sensor.

As shown in Table 1, the indication values of the first to fourth temperature control sensors before correction are all “600.0° C.”, and the temperature control is performed to bring the first to fourth mold sets to 600° .0C. However, variations occur in temperature of the mold sets (the upper molds and the lower molds) in an actual situation, and the indication values of the temperature measurement sensors are different from the indication value of the temperature control sensor as shown in Table 1.

Accordingly, individual differences, “0.3° C. (upper mold), −3.02° C. (lower mold)” between the first temperature control sensor and the second temperature control sensor, individual differences, “−1.0° C. (upper mold), −3.4° C. (lower mold)” between the first temperature control sensor and the third temperature control sensor, individual differences, “3.3° C. (upper mold), −0.6° C. (lower mold)” between the first temperature control sensor and the fourth temperature control sensor are respectively present. Among the second to fourth mold sets before correction, the maximum value and the minimum value of the individual difference of the temperature control sensor are “4.3° C. (upper mold), 2.8° C. (lower mold)”, respectively.

TABLE 2

| | | Reference | Subject to correction | | |
|---|---|---|---|---|---|
| Mold set | | First | Second | Third | Fourth |
| Correction amount | Upper | — | 0.0 | −1.0 | 3.0 |
| [C.°] | mold | | | | |
| | Lower | — | −3.0 | −3.0 | −1.0 |
| | mold | | | | |
| Indication value | Upper | 600.0 | 600.0 | 599.0 | 603.0 |
| of temperature | mold | | | | |
| control sensor | Lower | 600.0 | 597.0 | 597.0 | 599.0 |
| [C.°] | mold | | | | |
| Indication value | Upper | 599.3 | 599.1 | 599.7 | 599.0 |
| of temperature | mold | | | | |
| measurement sensor | Lower | 596.1 | 596.7 | 596.4 | 595.9 |
| [C.°] | mold | | | | |

Table 2 shows results of correction of temperature set at the time of temperature control by the second to fourth temperature control sensors. In Table 2, “correction amount” shows a correction amount (correction data) of temperature set at the time of controlling the temperature of the first to fourth temperature control sensors based on the individual differences shown in Table 1. Furthermore, “indication value of temperature control sensor” shows an indication value of the temperature control sensor after correction of set temperature. Moreover, “indication value of temperature measurement sensor” shows an indication value of the temperature measurement sensor after the correction of the set temperature. In this example, the individual difference (Table 1) of each of the temperature control sensors is not used as it is as the correction amount, but a value rounded off to the nearest integer is used as the correction amount.

As shown in Table 2, in the second mold set, the correction amount of the set temperature was determined to “−0.3° C. (lower mold)” based on the individual difference with respect to the first temperature control sensor, and the temperature control was performed to obtain “597.0° C. (lower mold)” as the indication value of the temperature control sensor. As a result, the indication value of the temperature measurement sensor (temperature of the second mold set) became “596.7° C. (lower mold)”, and a difference in temperature between the indication value “596.1° C. (lower mold)” of the temperature measurement sensor of the reference mold set and the indication value of the temperature measurement sensor (temperature of the second mold set) decreased. Therefore, the temperature condition of the second mold set was made close to the temperature condition of the first mold set.

Note that the reason why the indication value of the temperature measurement sensor changed from “599.0° C.” to “599.1° C.” even though the set temperature of the upper mold was not corrected in the second mold set is thought to be because of an intrinsic error of the temperature measurement sensor.

Furthermore, as shown in Table 2, in the third mold set, the correction amount of the set temperature was determined to “−1.0° C. (upper mold), −3.0° C. (lower mold)” based on the individual difference with respect to the first temperature control sensor, and the temperature control was performed to obtain “599.0° C. (upper mold), 597.0° C. (lower mold)” as the indication values of the temperature control sensor. As a result, the indication values of the temperature measurement sensor (temperature of the third mold set) became “599.7° C. (upper mold), 596.4° C. (lower mold)”, and a difference in temperature between the indication values “599.3° C. (upper mold), 596.1° C. (lower mold)” of the temperature measurement sensor of the reference mold set and the indication values of the temperature measurement sensor (temperature of the third mold set) decreased. Therefore, the temperature condition of the third mold set was made close to the temperature condition of the first mold set.

Moreover, as shown in Table 2, in the fourth mold set, the correction amount of the set temperature was determined to “3.0° C. (upper mold), −1.0° C. (lower mold)” based on the individual difference with respect to the first temperature control sensor, and the temperature control was performed to obtain “603.0° C. (upper mold), 599.0° C. (lower mold)” as the indication values of the temperature control sensor. As a result, the indication values of the temperature measurement sensor (temperature of the fourth mold set) became “599.0° C. (upper mold), 595.9° C. (lower mold)”, and a difference in temperature between the indication value “599.3° C. (upper mold), 596.1° C. (lower mold)” of the temperature measurement sensor of the reference mold set and the indication values of the temperature measurement sensor (temperature of the fourth mold set) decreased. Therefore, the temperature condition of the fourth mold set was made close to the temperature condition of the first mold set. The maximum value and the minimum value of the indication value of the temperature measurement sensor in the second to fourth mold sets after correction are “0.7° C. (upper mold), 0.8° C. (lower mold)”, respectively.

As above, the embodiment and the example to implement the disclosure for the optical element mold according to the present disclosure have been explained specifically, but the gist of the present disclosure is not limited to these descriptions, and should be interpreted widely based on the description of claims. In addition, it is needless to say that various changes and modifications based on these descriptions are included in the gist of the present disclosure.

For example, although the heaters 30a, 30b are arranged inside the upper mold 11 and the lower mold 12 in the optical element mold described above as shown in FIG. 1, a configuration in which a heater is arranged outside the upper mold 11 and the lower mold 12 to heat by radiation in a noncontact manner is also applicable.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of producing an optical element to produce optical elements having same properties among mold sets while performing temperature control on the mold sets to have predetermined set temperatures by using temperature control sensors that are inserted in the mold sets, the method comprising:
determining, as a reference mold set, a first mold set from among the mold sets;
determining a set temperature for the reference mold set;
acquiring reference data by measuring, by a temperature measurement sensor, a temperature of the reference mold set that has been heated such that a measurement value of a first temperature control sensor that is inserted in the reference mold set indicates the set temperature;
measuring, by the temperature measurement sensor, a temperature of a second mold set that has been heated such that a measurement value of a second temperature control sensor that is inserted in the second mold set becomes the set temperature, the second mold set being at least one of the mold sets other than the reference mold set;
calculating a correction value based on a measurement result obtained by the measuring and on the reference data;
determining a set temperature for the second mold set based on the set temperature for the reference mold set and on the correction value; and
performing temperature control on the mold sets to produce the optical elements, based on set temperatures determined for the respective mold sets.

2. The method of producing an optical element according to claim 1, wherein
the acquiring the reference data includes inserting the temperature measurement sensor at a position rotationally symmetrical to an insertion position of the first temperature control sensor about a center axis of the reference mold set, and
the calculating the correction value includes inserting the temperature measurement sensor at a position rotationally symmetrical to an insertion position of the second temperature control sensor about a center axis of the second mold set.
